(19) United States
(12) Patent Application Publication
(10) Pub. No.: US 2007/0200042 A1
(43) Pub. Date: Aug. 30, 2007

(54) Bag Holder

(76) Inventor: Christian Gschwend, Mannedorf (CH)

Correspondence Address: MORRISS OBRYANT COMPAGNI, P.C., 734 EAST 200 SOUTH, SALT LAKE CITY, UT, 84102, US

(21) Appl. No.: 10/581,697

(22) PCT Filed: Nov. 11, 2004
(86) PCT No.: PCT/CH04/00683

§ 371 Date: Apr. 18, 2007

(30) Foreign Application Priority Data
Dec. 6, 2003 (CH) 2078/03

(51) Int. Cl. B42F 13/00

(52) U.S. Cl. 248/339; 248/914

(57) ABSTRACT

The inventive device (11) for suspending a handbag to tables consists of a U-shaped elastic ribbon (13) provided with a spring, in particular a coated steel spring. Said ribbon comprises a first tensioned branch (15) provided with a first end area (22) and a second outward curved branch (25) provided with a second end area (33) which is bent inside U. The second end area (33), in the closed position thereof, is guided around the first end area (22) and is applied thereto from outside by pressure, said first end area being tensioned. When said two branches are pressed against each other in such a way that the end areas are mutually applied, they are oriented in a parallel direction with respect to each other.

The invention relates to a device for hanging or securing bags or similar objects on tables, chairs, plates or bars etc.

### BACKGROUND OF THE INVENTION

People who carry a handbag, bag, rucksack or likewise around with them, in a restaurant, in a bar or at hosts at home, often have the problem of depositing this bag at a suitable location. Often, the bag must be placed on the floor, on the lap or behind the back on the chair. This is an unsatisfactory situation with regard to hygiene, comfort and/or security.

For this reason on various occasions bag holders have been suggested, which permit a bag to be hung for example on a table top.

Such a bag holder is known from U.S. Pat. No. 2,692,108. This bag holder has a disk-like, circular adhesion part which is designed for resting on an upper side of a supporting surface and for the creation of a friction adhesion with this supporting surface. The lower side of the adhesion part is provided with rubber or felt. The upper side serves for decorative purposes. A catch eyelet projects from the edge of the adhesion-part. A hanger part projects from the edge of the adhesion part diametrically opposite the catch eyelet. The hanger part has a bent wire body of a resilient material which encompasses the adhesion part by half, and has a free end. The free end is movable between a first position in which it is detachably engaged with the catch eyelet, and a second position in which it is arranged below the adhesion part, in order to hang a handbag thereon. The hanger part is rotatably seated in the adhesion part. It may be pivoted from a first position in which it lies in the plane of the disk-like adhesion part, into a second position in which it lies in a plane normal to the plane of the adhesion part. The catch eyelet is formed on the hanger part as one piece and thereby co-rotates in a synchronous manner, so that the free end may be hung into the catch eyelet in every rotational position. Furthermore, a glove holder is formed on the bag holder. This is formed from a loop of rubber coated with fabric, which projects over the edge of the adhesion part at the same location as the hanger part, and may be hung into the catch eyelet.

A further such bag holder is known from FR-A-1.015.197. This is designed in the form of an arm circlet. A band of spring steel may be closed into a circlet and opened again. A rest disk is fastened on the band. A hook is formed on one side of the rest disk, which is shaped out of one end of the band, and into which the other end of the band which forms a second hook, may be hung. The rest disk is shaped as a shell whose opening is closed with a friction inlay. When the band is opened, this rest disk may be applied onto a table top. Thereby, the free end of the band extends below the table top. A bag or likewise may then be hung onto this free end of the band.

The disadvantage of these bag holders is the fact that the resilient metal part for attaching the bags thereto; needs to be bent in a complicated manner, in order to render possible the locking. Furthermore, these bag holders need to be composed of a plurality of different parts of different materials, and connected to one another. A further disadvantage is the fact that the material of the part which may be closed in an annular manner should on the one hand be resilient, and on the other hand should not become tarnished, so that its surface does not have to be looked after.

### OBJECT OF THE INVENTION

It is the object of the invention to provide such a holder whose annularly closable part may be manufactured in a very simple manner. With one advantageous embodiment of the invention, the surface of furniture on which the holder is fastened, and of bags and articles which are hung up with the holder, are treated gently.

### DESCRIPTION OF THE INVENTION

The object of the invention is achieved by a device according to claim 1. A device of the known type for hanging up handbags e.g. on tables, with an elastically resilient band which is U-shaped in the open position and which comprises a first extended limb with a first end region, and a second C-shaped outwardly arched limb with a second end region bent back into the inside of the U, and a connection arch connecting the two limbs, is a holder with which the two end regions may be hung within one another, which in this manner may be repeatedly closed into a ring and opened again. Thereby in a closure position, the second end region is led around the first end region and in this position presses from the outside against the first end region.

According to the invention, the object of the invention is achieved with such a holder by the characterising features of claim 1. With this device, the first end region is designed in an extended manner, and the bent-back second region bearing on the first region, by way of pressing the two limbs against one another, overlaps the first end region, wherein the two end regions in the region of the overlapping are directed essentially parallel to one another. These practically parallel overlapping regions of the end regions bear on one another in a flat manner. An interlocking of the end regions with one another, as is suggested in the context of the known devices described above, is not present. This permits the two end regions to be displaced only laterally towards one another, in order to open the ring. A lifting of the end regions from one another is not necessary. For this reason, the spring force of the band may be designed stronger than previously, without the handling ability becoming compromised due to this. Furthermore, the band may be very easily formed and may be coated with a different material.

The possibility of closing the holder into a ring has the advantage that is may be fastened on a loop of a bag or a rucksack in a practically unloseable manner. Furthermore, the object fastened on a bar with the holder may be secured by way of closure of the holder.

A curved first limb section of the second limb is designed connecting to the connection arch such that the greatest distance of the second limb to the first limb lies in a region between the connection arch and the first end region of the first limb. A second limb section of the second limb which connects to this first limb section and to which the second end region connects, in the unloaded and opened position of the holder, again approaches the first limb towards the second end region. The first limb section present connecting to the connection arch and preferably designed in a curved manner, in the loaded condition, is aligned practically at right angles to the first limb. A table end height may be bridged with this first limb section. The closed holder roughly describes a triangle whose corners are bent in a small radius and whose sides are extended or bent in a larger radius. This advantageous shaping of the holder ensures that when the holder is arranged lying with the first extended limb on a horizontal top, the load of an object hung on the second limb is arranged below the top. A stable hanging of a load is even possible on slanted or rounded table edges, since the engagement point of a small load may be freely displaced along the second arm, with large loads however lies at the end of the second arm, which is arranged below the end region of the first limb.

The two overlapping end regions preferably bear parallel on one another in the closed position. The parallel end regions overlap roughly by 1 to 2 cm, preferably 12 to 17 mm. This is a preferred design which permits a relatively easy actuation of the holder for opening and closure, as well as an adequate security from unintended opening.

The curvature of the second limb is advantageously designed such that the greatest distance between the first and the second limb, with an increasing opening of the U, displaces away from the connection curvature and towards the second end region. Heavier objects hang further away from the edge of a top than lighter ones.

The holder is preferably manufactured of band spring steel. Spring steel is not particularly attractive and corrosion resistant. In order to keep spring steel looking good, it must be cared for or refined. Furthermore, spring steel does not adhere particularly well to smooth surfaces, but tends to slide on these surfaces, and to damage these at the same time. But even a plastic having the required spring force has a poorly adhering surface. For this reason, the holder advantageously has a layer at least on its inner side, preferably even a cover covering the inner side and the outer side, of a material with high coefficients of friction, e.g. of leather, soft plastic (two-component plastic), of textile fabric, rubber or a combination of these materials. Materials with a high coefficient of friction is particularly useful on the inside of the extended limb. Such material may be arranged there as a cover or also as a layer which is bonded on, or be arranged there with a casting method or deposited in a different manner.

The cover is usefully formed as a flexible tubing or bag, said flexible tubing or bag being pushed over the spring steel band. The cover thereby is preferably designed closed at a short end in a bag-like manner and at the opposite short end comprises the bag opening. In the covered condition, the bag opening is closed with a separate closure part.

This closure part is usefully a metal or plastic clip, which encloses one end edge of the bent-back second region.

The inner side and the outer side of the cover may be of different materials. Then, the inner side of the cover is advantageously manufactured of soft plastic, in particular of a two-component plastic, cellular rubber or rubber. The outer side of the cover is usefully manufactured of an attractive leather or imitation leather, or also of plastic or a textile fabric. Since leather or imitation leather also has an adequate adhesion, the cover may also consist entirely of such a material. The cover may be striped over the metal core or e.g. be designed as an injection moulding periphery coating.

The holder is suitable for having decorations, e.g. decorative stones or ornaments on its outer side. The holder may also carry a watch. In one advantageous embodiment, a first transmitter and/or receiver is arranged on the holder, which is designed to communicate with a second transmitter and/or receiver, and which emits an alarm tone on reaching a defined distance of the two transmitters/receivers from one another.

Such a holder according to the invention is used for hanging up a load, e.g. a piece of clothing, a bag or a rucksack, on a piece of furniture or component, e.g. a table, or chair, a bar or a pipe. It may serve as a decorative piece and be worn as an armband or a wrist watch on the wrist.

### BRIEF DESCRIPTION OF THE FIGURES

The invention is explained in more detail by way of the Figures. There are shown in:

FIG. 1 schematically, an open holder on a horizontal top,

FIG. 2 schematically, the holder according to FIG. 1 with a hung bag,

FIG. 3 schematically, the closed holder according to FIGS. 1 and 20,

FIG. 4 a perspective sketch of a holder covered with a leather cover,

FIG. 5 a view of the closed holder according to FIG. 4 from the side of the first limb with an overlapping end region of the second limb,

FIG. 6 a cross section through a limb of the holder according to FIG. 4 or 5,

FIG. 7 a longitudinal section through the two overlapping end regions of the two limbs,

FIG. 8 a cross section through a limb of a holder, whose core consists of spring steel and whose cover consists of a peripheral injection, on which a watch is arranged.

### DESCRIPTION OF THE EMBODIMENT EXAMPLES

The U-shaped holder 11 consists of a band 13 (FIG. 6) of stainless spring steel, rimming in a bent manner. Spring steel has an advantageous resilience capability and a desired elasticity. The width of the band spring steel varies between 1.0 to 5.0 cm depending on the model, and is of significant importance with regard to the stability and reduction in the tendency to sideways movements under load. The material thickness of the band spring steel 12 is between 0.6 and 2 mm depending on the model.

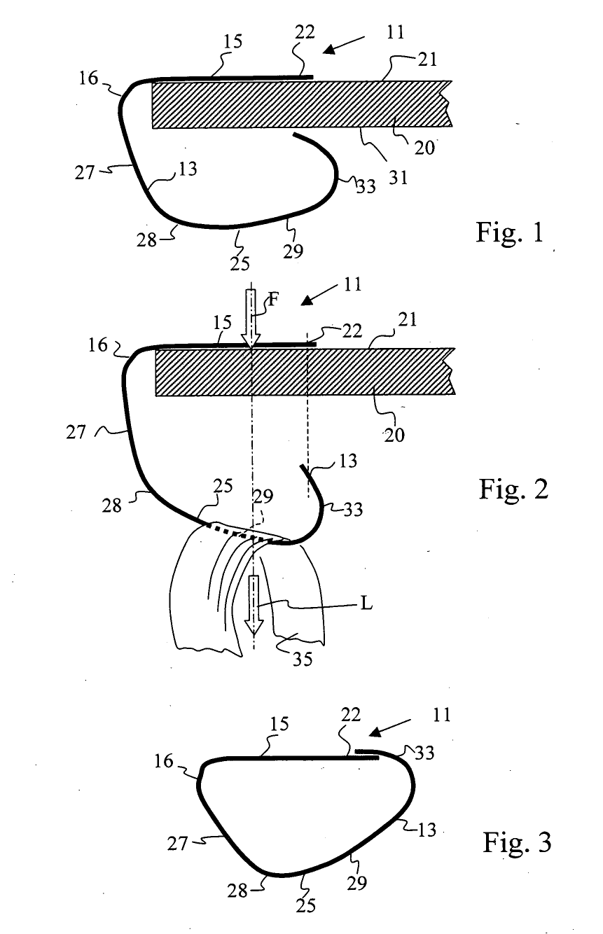

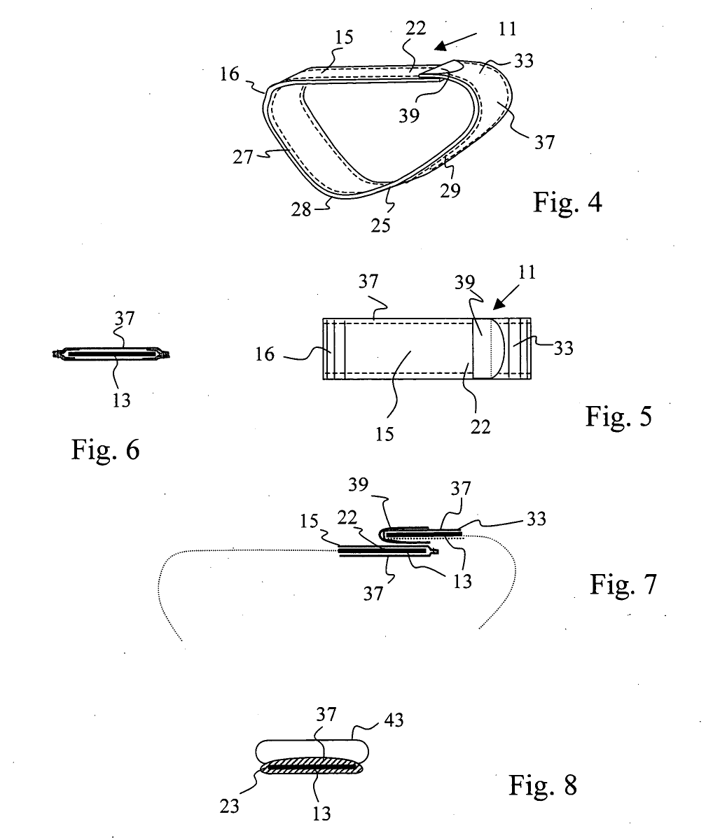

The holder 11 may be described as a band 13 shaped in a U-shaped manner with two limbs 15, 25 (FIG. 1). The first limb 15 which will be described here as the rest part 15 of the holder 11 is extended in a straight to slightly curved manner. The rest part 15 for example lies on the surface of a table 21 on use of the holder, and for this reason has an extended end region 22. Its length is between approx. 3 and 12 cm depending on the embodiment. Under loading, a suitable surface friction which counteracts any slipping of the holder 11 from the supporting surface 21 arises on account of a coating 23 (FIG. 87) or by way of the material (FIG. 4 to 7) covering the holder 11. The minimally curved rest part 15 extends according to the loading, the rest surface becomes larger and the frictional force counteracting a slipping is increased.

Here, the second limb 25 is also called load carrier 25. It is approx. 2 to 3 times longer that the rest part and begins connecting to a greatly bent connection arch 16 with a slightly curved first limb section 27. The second limb section 29 is connected subsequently to this first limb section 27 via a transition bending 28. This transition bending 28 therefore lies significantly below the table surface 21 or another supporting element 20. The edge, and in the normal case also the thickness of the supporting element 20, is overcome by way of the first limb section 27 and the two arches connecting thereto. A slight to moderately bent second limb section 29 follows the transition bending. This tends towards its end against the lower side 31 of the supporting element 21.

The second end region 33 of the second limb 25 is shaped in a greatly hook-like manner. If one observes the holder, whose rest part 15 lies horizontally, from the side, then the second end region 33 of the second limb 25 is located on a vertical line below the first end region 22 of the first limb 15. Depending on the opening width of the holder (this is the distance between the first end region 22 and the second end region 33) and the thickness of the supporting element 20, it may be the case that the holder produces a clamping effect on the supporting element 20. This has the advantage that the holder does not slip from the supporting element 20 when relieved from the load. The opening width is differently large, depending on the model, and varies between approx. 1 to 6 cm. If a bag, a rucksack or other object is hung up on the holder, then its carrier 35 (FIG. 2) is usually (i.e. when used on tables and likewise) positioned in the region of the second limb section 29 or a bending connecting thereto. In particular, the second limb section 29 is bent downwards to a greater or lesser extent (FIG. 2) depending on this position and the weight of the hung object. Since the holder 11 is formed of one piece and of elastic material, the force introduced into the second limb 25 is transmitted further to the first limb 15 and is borne by the supporting element 20. On account of the arising stresses in the material, the force ratios also change, depending on the load, and the engagement points of the force vectors are displaced in a parallel manner. The further the second limb section 29 is bent downwards under loading, the more does the load L, and thus also the force vector F which acts on the supporting surface 21, dislocate away from the table edge in the direction of the first end region 22 of the first limb 15. This in turn greatly reduces the danger of the holder 11 slipping from the supporting surface 21, and also permits a useful and stable application of the holder in situations, if for example a table edge is slanted, or only little space is available for the attachment of the holder 11.

Thanks to the elasticity of the material, the holder may be attached to supporting elements 20 of a different thickness. For this, in the open condition of the holder 11, the two end regions 22, 33 must be spread apart, until the opening width is larger than the thickness of the supporting element 20. On removal of the holder, the opening width reduces again to its original size on account of the material properties.

Depending on the embodiment, the holder 11 has a cover 37 of leather (e.g. FIG. 4 to 7), fabric or plastic, or also of a combination of these materials. Damage to the object to be hung up, to the surface 21 of the supporting element 20 and to other objects which come into contact with the holder are largely avoided by way of this. In order to reduces rapid appearance of wear and to take care of the surface of the holder 11, these may be additionally protected by a thin rubber layer at the vulnerable locations.

If it should once be impossible to attach the holder 11 on a table or likewise, then further variants are possible thanks to its design, specifically of hanging the holder 11 e.g. on back rests or arm rests of chairs, on bars or likewise:
If one hangs it on a back rest, then the first limb 15 bears on the back rest and the holder 11 mainly with the first limb section 27 or the connection arch 16 connecting thereto or the transition arch 28 bears one the back rest, and a carrier* 35 is supported in the curvature of the second end section.
If one hangs the holder 11 in the opened condition on an arm rest, a pipe or likewise, then it likewise lies mainly in the region of the connection arch 16 between the first limb 15 and the first limb section 27 of the second limb 25 as well as the second limb 25, on the supporting element. The carrier 35 is hung in the curvature of the second end section 33.
If the holder 11 however is closed into a ring, then it may be fixed at suitable objects at any position. The different sections of the holder 11 then assume the task of a load carrier or rest part, depending on the position.

The holder 11 may be closed by way of pressing the first end region 22 and the second end region 33 against one another. Thereby, the load carrier 25 extends, and the first end region 22 is pushed below the second end region 33, whereupon the two end regions overlap to a lesser or greater extent depending on the model. A useful minimal overlapping of 1 cm should be ensured. The overlapping parts of the end regions 22, 23 thereby lie on parallel planes (FIG. 3).

In the closed condition, the holder 11 when it is for example closed around a bag carrier 35, is carried around safe from loss and is always at hand. Hung on the carrier 35 of a bag, it may thereby also be a decorative trinket. Furthermore, it offers a certain amount of protection from theft of the object fixed with the holder 11.

FIG. 4 shows a covered holder 11. The cover 37 consists of a leather flexible tubing. The leather is sewn together at a short end and along tow oppositely lying longitudinal sides of the flexible tubing. The open short side is not sewn together. This open short side is pulled over the bent band spring steel bow from the first end region. The opening of this bag-like leather flexible tubing is therefore finally at the second end region 33. This opening is closed with a closure element 39 of metal. This closure element 39 is bent up around the end edge of the second end region 33.

This closure element 39 and the cover 37 is shown in the view according to FIG. 5. The first end region 22 is applied below the second end region 33 and with the spring force of the band spring steel presses from the inside against the second end region 33. The overlapping of the two end regions is 15 mm long.

From the section according to FIG. 6, it is deduced that the cover 37 has an outer layer and an inner layer, said two layers being sewn together along the edge of the band spring steel 13. The inner layer ensures the required slip resistance of the holder 11 and the outer layer serves for an elegant appearance.

The overlapping is shown in section in FIG. 7. The bow of band spring steel presses the two end regions 22, 23 against one another and thus forms a ring. The closure element 39 is arranged at the second end region, so that the first end region is as flat as possible and may lie on the table surface over large area with a slip-resistant material.

Concluding, it may be said that a holder 11 which is U-shaped in the opened position for hanging handbags, bags and similar objects, is formed from band spring steel strips 13. The holder 11 has a first extended limb 15 with a first extended end region 22. The holder 11 has a second limb 25 of the same strip 13 which connects to the first limb 15 with a connection arch 16. The second limb of the U which is outwardly curved has a second end region 33 bent back into the inside of the U. With this holder 11, the curved shape and length of the second limb 25 is matched to the length of the first limb 15 so that the end regions 22, 33 which bear on one another by way of pressing the two limbs 15, 25 against one another overlap on a length of about 10 mm. By way of this, the holder 11 may be repeatedly closed into a ring and opened again. In the annular closure position, the second end region 33 is led around the first end region 22. The holder is preferably covered with a material which has a high friction coefficient. It is possible to decorate the outer side of the holder, or to use it as advertising surface. The holder 11 permits objects such as bags, rucksacks etc. to be hung up e.g. on table tops, back- and arm rests of chairs, and bars. Thanks to the lovability of the holder 11, it may be hung on bags and be carried around as a decorative piece or as a watch. It is thus always available when required.

A cross section through a limb of a further embodiment example is shown in FIG. 8. With this holder, the core is provided with a peripheral injection moulding. This peripheral injection moulding consists of a two-component plastic. A watch 43 is furthermore fastened on the first limb.

The watch in the present case has a transmitter/receiver unit integrated therein, which cooperates (arrow) with a second transmitter/receiver unit (45) designed as a key ring. Both transmitter/receiver units emit a signal sound as soon as they are distanced more than 5 m from one another. The critical distance may be set on a second transmitter/receiver unit. The signal sound of the first receiver unit only ends when the two cooperating transmitter/receiver units are closer to one another than the critical distance for a certain time duration, or it may be switched off by actuation of the second transmitter/receiver unit. The signal sound of the second

1. A device for hanging handbags and other items from tables and other structures, comprising:
a band which is U-shaped in an open position, of an elastically resilient material which comprises:
a first, extending limb which ends in a first end region, and
a second limb which is curved outward in a C-shaped manner and which ends in a second end region bent back into an inside of the U-shape, and
a connection arch connecting the first and second limbs,
the first and second end regions may be selectively spread apart and thus the band may be repeatedly closed into a ring and opened again,
wherein in a closed position, the second end region is led around the first end region and in this position presses from an outside against the first end region,
second end region overlapping the first end region) in the closed position, and each having a planar surface in a region of overlapping, and substantially parallel to one another in the closed position.

2. The device according to claim 1, further comprising a layer formed on an inner side of the band, consisting of a material with a higher friction coefficient compared to the elastically resilient material of the band.

3. The device according to claim 1, further comprising a cover completely enveloping the band, of a material with higher friction coefficient than steel.

4. The device according to claim 3, wherein the cover comprises at least one of a flexible tubing and a bag extending.

5. The device according to claim 3, wherein the cover has a first closed end in a bag-like manner, and an oppositely lying second end comprising a bag opening, said bag opening being closed with a separate closure part.

6. The device according to claim 5, wherein the closure part is comprised of at lest one of a metal clip and a plastic clip which encompasses an end edge of the second end region.

7. The device according to claim 3, wherein the cover is formed by at least one of a coating and a peripheral casting of the elastically resilient material of the band.

8. The device according to claim 3, further comprising decorations on the outer side of the cover.

9. The device according to claim 3, wherein the cover on an inner side of the band consists of different material than the cover on an outer side of the band.

10. The device according to claim 9, wherein on the inner side of the band, the cover is manufactured of at lest one of leather, imitation leather, plastic and textile fabric.

11. The device according to claim 3, wherein on the outer side of the band, the cover is manufacture of at least one of leather, imitation leather, plastic and textile fabric.

12. The device according to claim 1, further comprising, a first communicating device coupled to the band, which is equipped to communicate with a second communicating device that is separated from the band and which emits an alarm sound when the first and second communicating devices are separated a certain distance from each other.

13. The device according to claim 1, wherein the elastically resilient material comprises spring steel.

14. The device according to claim 2, wherein the layer is comprised of at least one of rubber, soft plastic, imitation leather and leather.

15. The device according to claim 3, wherein the cover is comprised of at least one of leather, plastic, textile fabric, and rubber.

16. The device according to claim 7, wherein the covering is comprised of a peripheral injection molding with two-component plastic.

17. The device of claim 8, wherein the decorations comprise at least one of gems, a print on the cover and a watch.
